(19) United States
(12) Patent Application Publication
(10) Pub. No.: US 2010/0202627 A1
(43) Pub. Date: Aug. 12, 2010

(54) Docking System Employing a Solar Energy Charging System

(76) Inventor: Randolph Gray, Round Rock, TX (US)

Correspondence Address: Randolph Gray, 16721 Chamonix Terrace, Round Rock, TX, 78681, US

(21) Appl. No.: 12/688,328

(22) Filed: Jan. 15, 2010

Related U.S. Application Data
(60) Provisional application No. 61/144,804, filed on Jan. 15, 2009.

(51) Int. Cl. H01M 10/46; H04R 1/02; H04B 3/00

(52) U.S. Cl. 381/77; 320/101; 381/332

(57) ABSTRACT

A portable speaker docking system employing a solar energy charging system and a cooling system is provided. In one form, a speaker docking apparatus for connecting and charging an electronic device can include an housing with internal power storage operable to connect and charge an electronic device using converted solar energy. The apparatus can further include a solar energy charge system including a solar panel coupled to an exterior portion of the housing. The solar module assembly can be fixed to, detachable, an/or adjustable on the docking station. The solar module assembly can feature internal power storage operable to charge an electronic device. The apparatus can further include a cooling system including a fan system operable to cool the docking system and/or the solar panel.

### CROSS REFERENCE TO RELATED APPLICATION

This application claims priority to United States Provisional patent application entitled “Docking System Employing a Solar Energy Charging System” having application Ser. No. 61/144,804 and filed on Jan. 15, 2009 and herein incorporated by reference.

### FIELD OF THE DISCLOSURE

The present disclosure generally relates to solar energy and, more particularly, to a portable docking system employing a solar energy charging system.

### BACKGROUND

Power utilization of conventional hand-held electronic devices can vary significantly depending on the application and utilization of a device. Some electronic devices include connectivity abilities for charging and synchronizing data with a host computer. For example, some MP3 players offer a docking port for connecting a charging and docking station or a charging cable for connectivity to a host computer, or a docking station with a speaker system for broadcasting sound to external speakers and offering AC or DC recharging capabilities. Each mode may have separate power demands.

Other electronic devices, such as satellite radios, uses a docking station to charge and to transmit audio signals to a home receiver system, a car audio system, or a portable speaker system. For example, some satellite radios offer an assortment of docking options to receive a digital signal which is broadcast from a satellite. The docking stations may use an internal or external antenna, transmit audio signal through cable connectivity or by FM modulators, and supply electricity for operation and recharging batteries if required. Each mode may have separate power demands.

Portability is a main feature for personal electronic devices. For example, MP3 players, cell phones, smart phones, and satellite radios, offer personal music, video, and/or picture viewing in a personal portable device. These devices have internal rechargeable batteries needed for operation for a specified period of time. These devices would be un-operable if no charging facility or energy storage is available. Each device has different power demands. Power consumption of electronic devices may increase as a function of communication and processing data advances.

### SUMMARY OF THE INVENTION

In accordance with teachings of the invention, a docking station employing a solar energy charging system is provided. According to one aspect of the invention, a portable docking system for charging an electronic device is disclosed. The portable docking station includes at least one solar panel integrated as part of the exterior surface of the dock housing operable to charge a rechargeable battery of the electronics device or the rechargeable battery of the docking station or both rechargeable batteries. The docking station can feature a USB port or other industry standard connecting port to connect an additional electronic device.

According to another aspect of the invention, a docking station employing a solar energy charging system is disclosed. The docking station includes at least one removable and/or adjustable solar module assembly connected to the dock housing operable to charge a rechargeable battery of the electronic device, or a rechargeable battery of the dock housing, or a rechargeable battery of the solar module assembly or all of the rechargeable batteries. The docking station and the solar module can feature at least one USB port or other industry standard connecting port to connect and charge an additional electronic devise. The docking station and/or the solar module assembly can include a fan cooling system.

According to another aspect of the invention, a speaker docking station employing a solar energy charging system is disclosed. The speaker docking station includes at least one solar panel integrated as part of the exterior surface of the speaker dock operable to charge a rechargeable battery of the electronic device or the internal rechargeable battery of the speaker dock or both rechargeable batteries.

According to another aspect of the invention, a speaker docking station employing a solar energy charging system is disclosed. The speaker docking station includes at least one removable and/or adjustable solar module assembly connected to the dock housing operable to charge a rechargeable battery of the electronic device, or a rechargeable battery of the dock housing, or a rechargeable battery of the solar module assembly or all of the rechargeable batteries. The docking station and the solar module can feature at least one USB port or other industry standard connecting port to connect and charge an additional electronic devise. The speaker docking station and/or the solar module assembly can include a fan cooling system.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a portable speaker docking system with a solar charging solution in a fixed position according to one aspect of the disclosure;

FIG. 2 illustrates a portable speaker docking system with a solar charging solution in a closed position according to one aspect of the disclosure; and

FIG. 3 illustrates a portable speaker docking system with a solar charging solution in a detached position according to one aspect of the disclosure.

FIG. 4 illustrates the front view of a portable speaker docking system with a solar charging solution in a fixed position according to one aspect of the disclosure;

FIG. 5 illustrates the rear view of a portable speaker docking system with a solar charging solution in a fixed position according to one aspect of the disclosure;

FIG. 6 illustrates a portable speaker docking system with a solar charging solution in an upright position according to one aspect of the disclosure; and

FIG. 7 illustrates a portable speaker docking system with a solar charging solution in a detached position according to one aspect of the disclosure.

### DESCRIPTION

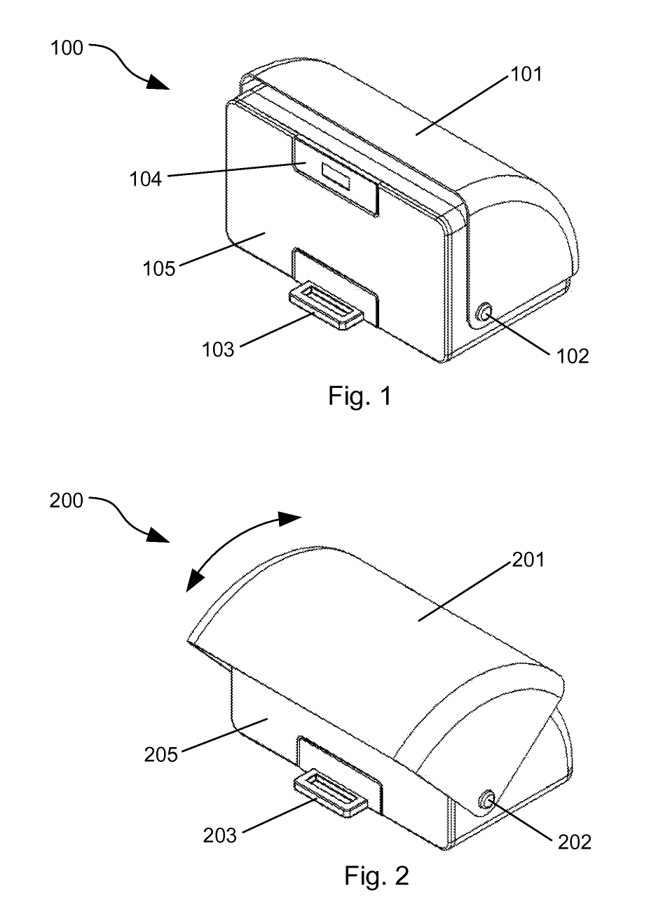

Advantageous embodiments of the disclosure are provided in FIGS. 1-7 and illustrate solar charging of various types of multimedia devices used in mobile environments.

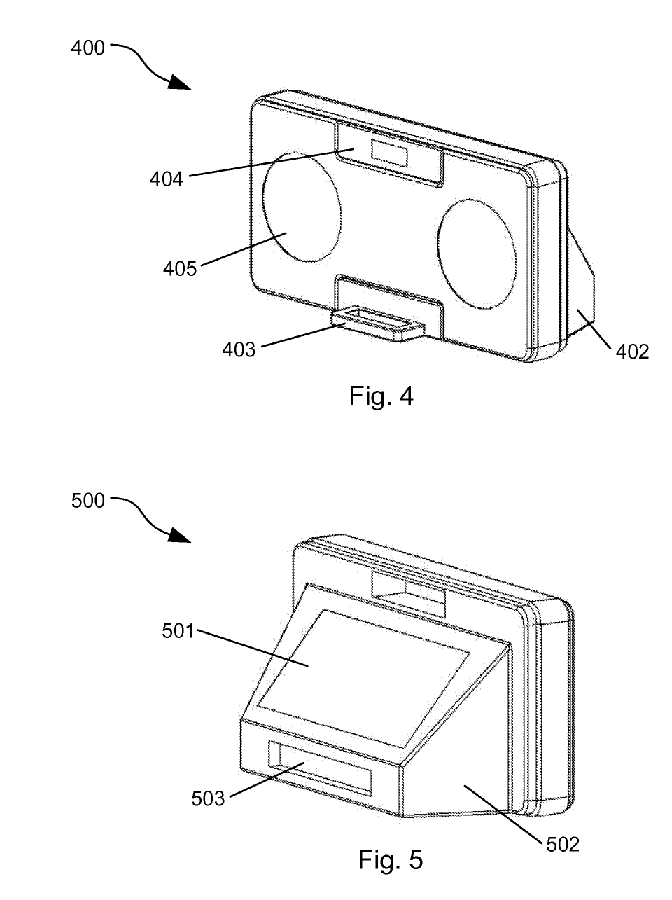

FIG. 1, FIG. 4, and FIG. 5 illustrates a portable speaker dock (105, 405, 502) with a solar charging solution (101, 501) presented in a fixed position according to one aspect of the disclosure. The portable speaker docking system can include at least one thin-film solar panel operable to output an approximate range of power (Watts). A thin-film technology solar panel is used for the weight advantage (light-weight) and design flexibility. A standard single or multi-crystalline cell solar panel can be used for more efficient power, but with added weight. This will be an option for the larger solar speaker docking systems. The shell of the speaker dock can be provided as a hard case and can include durable aluminum laminated material, an aluminum formed shell, a polycarbonate shell, or various other types of materials to form the housing of the speaker docking station (402, 502). In one form, the housing can be provided as a waterproof housing (402, 502). In another form, the speaker dock can include a charge port for charging specific types of electronic devices such as an iPod, satellite radio, cell phone, or other type of electronic device (103, 203, 303, 403). In another form, the speaker dock can include an amplifier to boost the audio signal to the speakers in the housing. The speaker dock can also include but not limited to an AM/FM radio, a clock, an alarm, a CD player, and any required antenna system for radio or satellite reception (104, 304, 404).

FIG. 2 illustrates a portable speaker dock (205) with a solar charging solution (201) presented in a closed or hooded position according to one aspect of the disclosure. The solar module assembly can be rotated to position the solar panel to optimum positioning to the sun. The solar module can also provide shade for the speaker dock unit and the attached personal electronic device (mp3 player, iPod, satellite radio, cell phone, etc. . . . ). The solar module assembly can incorporate a cooling fan to provide air circulation and cooling for the speaker docking unit and the solar module assembly (205). The speaker dock can also include one or more auxiliary batteries, such as lithium ion batteries that can be charged using solar energy or using an AC adapter and plug. The speaker dock can also include multiple Universal Serial Bus (USB) ports that can be used to access power stored within the one or more auxiliary batteries.

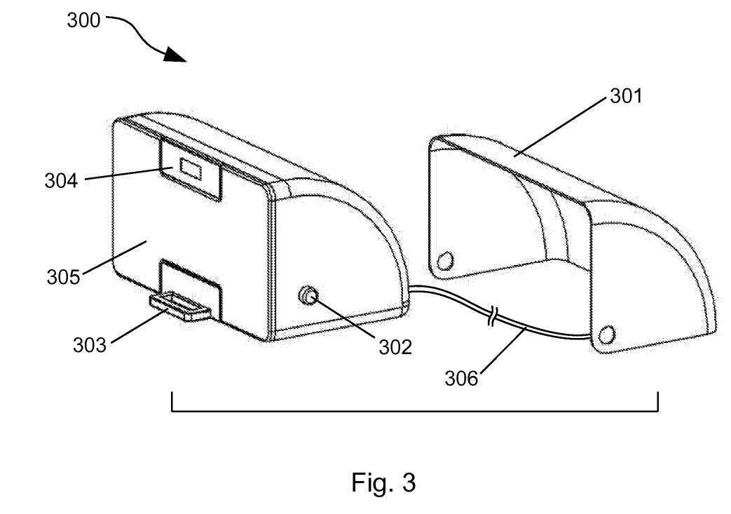

FIG. 3 and FIG. 7 illustrates a portable speaker dock (305, 702) with a solar charging solution (301, 701) presented in a detached position according to one aspect of the disclosure. The system can include a solar module assembly that is removable enabling remote placement of the solar module assembly (301, 701) under the sun. The speaker dock can remain in the shade or in a covered or enclosed area. The system can include a cable connecting the solar panel to the speaker dock (306, 704). The cable can utilize a standard power connector or a USB or mini USB connector enabling connectivity with other devices with similar power requirements for operation or recharging. The solar module assembly can be connected to the main housing a male or female plug connector. The speaker dock can include a USB port for power input from the solar module assembly or other USB enabled power sources such as a desktop computer or laptop computer. The system can also include multiple USB ports for power output to other electronic devices. The speaker dock housing can accept power from an AC source using an appropriate AC to DC adapter. The system can also include a power charge controller to regulate the power output from the solar module assembly to the internal batteries and the USB ports.

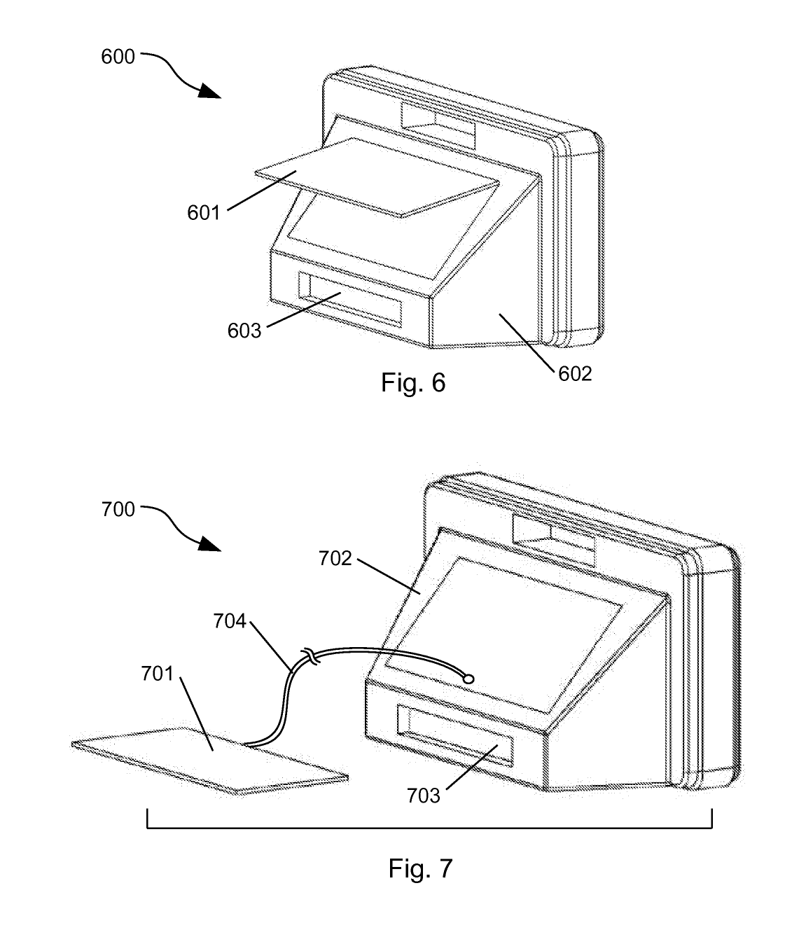

FIG. 6 illustrates a portable speaker dock (602) with a solar charging solution (601) presented in an upright position according to one aspect of the disclosure. The solar module assembly can be rotated to position the solar panel to optimum positioning to the sun.

During operation, the solar panel can trickle charge the internal battery of the speaker dock or the internal battery of the solar module assembly which can supply additional power to a satellite radio, cell phones, iPods, or other electronics. The solar panel, exposure to the sun and the auxiliary battery and amplifier typically produce heat, and upon sensing a specific temperature value, the cooling fans can be switched on to cool the speaker dock and/or the solar panel. In one form, the temperature sensors can be switched on and off manually. In another embodiment, power to charge the auxiliary battery can also be supplied by standard AC using an AC adapter (503, 603, 703). Additionally, providing a solar panel allows the user to charge electronic devices in remote places. This can be an advantage for the outdoorsman, during outdoor recreation, mobile professional, military personnel, and developing third world countries that lack the infrastructure to access electrical power.

The system further includes a fan controller that can be powered using the energy repository. The fan controller can be coupled to a first fan, a second fan, a third fan, or additional fans as desired. Temperature sensors can be coupled to the fan controller and can be used to provide an input to the fan controller for controlling operation of one or more of the fans. A manual fan switch can also be used to manually to activate or deactivate one or more of the fans as desired.

Note that although an embodiment of the disclosure has been shown and described in detail herein, along with certain variants thereof, many other varied embodiments that incorporate the teachings of the disclosure may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the disclosure is not intended to be limited to the specific form set forth herein, but on the contrary, it is intended to cover such alternatives, modifications, and equivalents, as can be reasonably included within the spirit and scope of the disclosure.

What is claimed is:

1. A docking apparatus for connecting and charging an electronic device comprising of:
a housing operable to connect and charge an electronic device using solar energy;
a solar energy charge system including at least one solar panel coupled to an exterior portion of the housing.

2. A docking apparatus of claim 1 with a detachable solar module assembly connected to the housing with a cable or with a male or female connector.

3. A docking apparatus of claim 1 with an adjustable solar module assembly.

4. A docking apparatus of claim 1 with a rechargeable battery operable to store converted solar energy and provide power to operate and recharge the electronic device, built into the main housing.

5. A docking apparatus of claim 1 with a rechargeable battery operable to store converted solar energy and provide power to operate and recharge the electronic device, built into the solar module assembly.

6. A docking apparatus of claim 1 with a USB port or other industry standard connection port in the main housing for connecting and charging an additional electronics device.

7. A docking apparatus of claim 1 with a USB port or other industry standard connection port in the solar module assembly for connecting and charging an additional electronics device.

8. A docking apparatus of claim 1 with a cooling system operable to cool the housing.

9. A docking apparatus of claim 1 with a cooling system operable to cool the solar module assembly.

10. A speaker docking apparatus for connecting and charging an electronic device comprising of:
a housing operable to connect and charge an electronic device using solar energy;
a solar energy charge system including at least one solar panel coupled to an exterior portion of the housing;
a speaker system built into the housing to broadcast audio signals from an electronics device.

11. A speaker docking apparatus of claim 10 with a detachable solar module assembly connected to the housing with a cable or a male or female connector.

12. A speaker docking apparatus of claim 10 with an adjustable solar module assembly.

13. A speaker docking station of claim 10 with a rechargeable battery operable to store converted solar energy and provide power to operate and recharge the electronic device, built into the main housing.

14. A speaker docking station of claim 10 with a rechargeable battery operable to store converted solar energy and provide power to operate and recharge the electronic device, built into the solar module assembly.

15. A speaker docking station of claim 10 with a USB port or other industry standard connecting port in the main housing for connecting and charging an additional electronics device.

16. A speaker docking station of claim 10 with a USB port or other industry standard connecting port in the solar module assembly for connecting and charging an additional electronics device.

17. A speaker docking station of claim 10 with an antenna resource for receiving broadcast signals.

18. A speaker docking station of claim 10 wherein the resource includes a satellite radio antenna.

19. A speaker docking system of claim 10 with a cooling system operable to cool the speaker housing.

20. A speaker docking system of claim 10 with a cooling system operable to cool the solar module assembly.
